(19) United States
(12) Patent Application Publication
(10) Pub. No.: US 2002/0115487 A1
(43) Pub. Date: Aug. 22, 2002

(54) Gaming device network

(76) Inventor: William R. Wells, Reno, NV (US)

Correspondence Address: R. Scott Weide, Weide & Associates, Ltd., 11th Floor, Suite 1130, 330 South 3rd Street, Las Vegas, NV, 89101, US

(21) Appl. No.: 09/788,107

(22) Filed: Feb. 16, 2001

(51) Int. Cl. G06F 17/00

(52) U.S. Cl. 463/42

(57) ABSTRACT

A method and apparatus for permitting communications with a gaming device is disclosed. In one embodiment of the invention, the invention is a network including a host or gaming gateway which is associated with one or more other networks/systems which may operate in accordance with different protocols, and a communication interface associated with each gaming device on the network. An optical communication link is provided between the gaming gateway and the gaming devices. The gaming gateway and each communication interface are arranged to bi-directionally transmit and receive data over the optical communications link. Preferably, information associated with the plurality of other networks/systems associated with the gaming host are transmitted over the single network linking the host and gaming devices. In one embodiment, the network has a loop topography, and the gaming gateway is adapted to detect a break in the network loop and re-route information over the appropriate portion of the link to communicate with each gaming device. In one or more embodiments, a security monitoring system is associated with the network. In one embodiment, this system includes at least one sensor for detecting the position of a gaming device cabinet access door. The security monitoring system and the communication interface for the gaming device are provided with an independent or backup power supply so that they remain operational when power is shut off or lost to the remainder of the gaming device. During times when the main power supply is not available, the communication interface and security monitoring system are arranged to turn on at specified time intervals and send packetized information to the host for monitoring.

### FIELD OF THE INVENTION

The present invention relates to gaming devices, and more specifically, to a method and apparatus for transmitting information to and from one or more gaming devices.

### BACKGROUND OF THE INVENTION

A large number of gaming devices are in use which present one or more games for play by a player. Such gaming devices include slot machines, video poker machines and lottery devices.

For a variety of reasons, it is often desirable to link gaming devices to one or more remote devices, and/or link two or more gaming devices to one another. For example, a gaming operator may desire to monitor the operation of a gaming device from a remote location. This requires that information be transmitted from the gaming device to the remote device. The transmitted information may include wager amounts, payouts, time of play and a wide variety of other information. Information may also be transmitted to the gaming machine from the remote device, such as polling information triggering the gaming device to provide specified data.

Multiple games may be linked together for purposes of establishing jackpots. In a known gaming method, a jackpot is established which is dependent upon a percentage of the revenue or take from a plurality of gaming devices. In this arrangement, a small percentage of the wager or take associated with each gaming device is added to that of others, providing for a much larger jackpot than could normally be offered by a single gaming device. When a player receives one or more predetermined winning criteria with one of the gaming devices, that player may win all or a percentage of the jackpot amount. In this arrangement, a progressive network is formed comprising a plurality of the individual gaming devices linked to one another.

In the jackpot linking arrangement, jackpot participation information may be transmitted from each remote device to a central location for computation of an aggregate jackpot, and then this aggregate jackpot amount information is transmitted back to each gaming machine. The total jackpot information may be displayed to a player of each gaming device as added enticement for the player to play the game.

There are a number of problems which must be considered when attempting to establish communication links in a network of one or more gaming devices. These problems make it difficult to satisfy the different, and sometimes competing, desires of the device manufacturer, operator and player.

Currently, functions such as those described above are accomplished by linking the gaming devices to independent networks. For example, a first system may be arranged to manage and monitor the progressive aspect of gaming device operation. Each gaming device is connected to this system via a first network, the network specifically configured to interface with the progressive system. One or more gaming devices may include a player tracking feature and be linked to a player tracking system. The player tracking system, which may be unique to a particular property, is different and separate from the progressive network and system. Thus, each gaming device which includes the player tracking feature includes a separate connection to a second player tracking network. Each gaming device may also be interconnected to a number of other networks through other independent connections.

There are a variety of reasons for the current arrangement. First, the various systems, such as a progressive system and a player-tracking system, may be operated by different entities. A player-tracking system may be property dependent, while a progressive system may be operator dependent. The various gaming devices are all configured differently as well, with some comprising new devices adapted to connect to several different systems, and some comprising older devices which are adapted to connect to only specific systems.

From the above it will be appreciated that one problem is providing a network which will permit the transfer of information associated with a variety of differing systems to and from a variety of gaming devices which are configured differently.

When considering a network arrangement, it is also desirable to make each gaming device as simple to install, operate and repair as possible. If installation, operation and repair of a gaming device is complex, then the associated costs of operation rise, reducing the net revenue to the operator.

It is necessary for the communication network associated with the gaming device(s) to be reliable. In many instances, information is obtained from each gaming device to ensure the security of the device and the integrity of the gaming network as a whole. It is extremely important to ensure that a gaming machine or the network as a whole is not tampered with, resulting in the theft of monies. For example, a gaming device may be frequently polled from a central remote computer. If a gaming device does not respond then a security breach in the gaming device or network may have occurred and appropriate security measures may be necessary. If the network is not reliable, either because it is easily breached or broken, then significant losses to the gaming operator may result during the time the gaming device is not playable.

One particular problem with gaming devices arises because they are often moved. Gaming devices are often grouped in banks and moved about the floor of a casino dependent upon the variations of the desired layout of the casino floor. A problem with this arrangement is that the network links to one or more of the gaming devices are often broken during movement. A break in the network may trigger a security measure of shutting down other machines located remote from the affected machines in order to ensure the integrity of the system and prevent tampering. Taking the devices out of service is, again, costly to the operator because the device can not generate revenue when not in use.

In some instances, the location of gaming devices in a casino makes it difficult to maintain the network communication links. Banks of the gaming machines may be located centrally within a casino. Wiring is run from remote locations under the carpeting to the banks of gaming devices. Frequently, very heavy items such as change carts are moved over the carpeting around the gaming devices. This equipment may damage network equipment.

Another problem with network links is that they are susceptible to significant electrical interference. Static electricity is often generated by equipment and persons walking over the carpeting. This electric charge may be discharged into the network via the links or through a gaming device. The discharged electricity may interrupt data signals or even damage equipment.

Quite often, a single gaming device in a bank of devices must be repaired. It is desirable to disconnect the single gaming device in need of repair from the network without affecting the other associated gaming devices.

Another problem with current gaming device networks is the limitation in the rate of data transfer. In many instances, very large numbers of gaming devices are being interconnected over great distances. In order to monitor the gaming devices accurately, large amounts of data must be transferred over short periods of time. It is also desirable to provide real-time audio and video, both of which require high data transfer rates. Current gaming networks suffer from bandwidth limitations.

It is desirable to provide an improved communications link or network for one or more gaming devices.

### SUMMARY OF THE INVENTION

The present invention comprises a method and apparatus for permitting communications with a gaming device. In accordance with one embodiment of the invention, the invention comprises a network including a host or gaming gateway and a communication interface associated with each gaming device on the network. A communication link is provided between the gaming gateway and the gaming devices. The gaming gateway and communication interfaces are arranged to bi-directionally transmit and receive data over the communications link. In one embodiment, the communications link is an optical communications link.

Thus, in one embodiment, the network comprises a host communication device capable of transmitting and receiving data, at least one gaming device, a communication interface associated with each gaming device, and a communication link provided between each one gaming device and the host communication device, the communications link comprising at least one optic fiber, the host communications device and each communications interface associated with a gaming device configured to bi-directionally communicate data over the communication link. In one embodiment, an optic fiber extends from the gaming gateway to a first gaming device. Another optic fiber extends from the first gaming device to the next gaming device. Another optic fiber extends from the last gaming device back to the gateway. In this fashion, a network loop topography is formed.

In one embodiment, at least the gaming gateway is adapted to detect a break in the network. The gaming gateway is then adapted to re-route information over an alternative appropriate portion of the link to communicate with each gaming device.

In one embodiment, the gaming gateway and communication interface(s) employ a particular architecture/data transmission protocol. In a preferred embodiment, this is the IEEE-1394 architecture/protocol. In this embodiment, each communication interface includes a physical layer comprising hardware for connecting the optic fibers. A link layer is provided in communication with the physical layer, the link layer comprising data transmitting and receiving hardware. A transaction layer is in communication with the link layer. The transaction layer comprises firmware for receiving and sending commands. The link and transaction layers communicate with a machine interface of the gaming device.

In one embodiment, the gaming gateway is associated with not only the one or more networks including the gaming devices, but one or more outside networks or systems. In particular embodiments, these other networks/systems may comprise independent player tracking or progressive systems. Some or all of these other networks or systems which are associated with the gaming gateway may operate in accordance with protocols different than that of the network including the gaming devices. For example, while the network including the gaming devices preferably operates using an IEEE-1394 protocol/architecture, the gaming gateway may interface with outside or other networks operating in accordance with other protocols, such as Ethernet or ATM. The information associated with the variety of independent outside or backbone networks is transmitted via the gaming gateway over the single network connecting the gaming devices.

In one or more embodiments, a security monitoring system is associated with the network. In one embodiment, this system includes at least one sensor for detecting the position of a gaming device cabinet access door. The security monitoring system and the communication interface for the gaming device are provided with an independent or backup power supply so that they remain operational when power is shut off or lost to the remainder of the gaming device. During times when the main power supply is not available, the communication interface and security monitoring system are arranged to turn on at specified time intervals and send packetized information to the host for monitoring.

In one or more embodiments, data may be transmitted in a variety of formats. In an embodiment where optic fibers are utilized, the visible light may comprise a data carrier wave. Other data carriers may be used, however, such as carrier waves having a variety of other frequencies, such as those known as infrared light.

In accordance with the invention there is provided a vastly improved gaming network. The single network allows communication between a gaming device and a plurality of differing systems which may operate in accordance with differing protocols. The network is fault tolerant in that a break in the network does not interrupt communications between the gateway or host and all of the gaming devices. The network also provides for very high speed data transfer, facilitating uploading of larger programs or other data, and allows for a larger number of devices to be on the same network. The network is reliable and easy to maintain. In one embodiment, network verification or operation can be established by viewing or monitoring components thereof for signs of operation in the form of visible light forming the data carrier. The network is not susceptible to common forms of interference, such as electromagnetic fields and electrostatic discharge (ESD).

Further objects, features, and advantages of the present invention over the prior art will become apparent from the detailed description of the drawings which follows, when considered with the attached figures.

### DESCRIPTION OF THE DRAWINGS

FIG. 1 illustrates a plurality of gaming devices connected by a network of the present invention;

FIG. 2 is a schematic diagram of a gaming network in accordance with the present invention;

FIG. 3 is a schematic diagram of a communication interface of a gaming device of the gaming network illustrated in FIG. 2; and

FIG. 4 illustrates a gaming device security system of the present invention.

### DETAILED DESCRIPTION OF THE INVENTION

The invention is a gaming device network and a method for transmitting information to and/or from one or more gaming devices. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the present invention comprises a communications network for a plurality of gaming devices, the network providing high-speed and reliable data transfer and overcoming a variety of the above-stated problems. The network includes communication interfaces associated with each gaming device and one or more hosts or other common devices, and communication links in the form of optic fibers. The network is arranged so that data may be sent in bi-directional fashion between the gaming devices and the host.

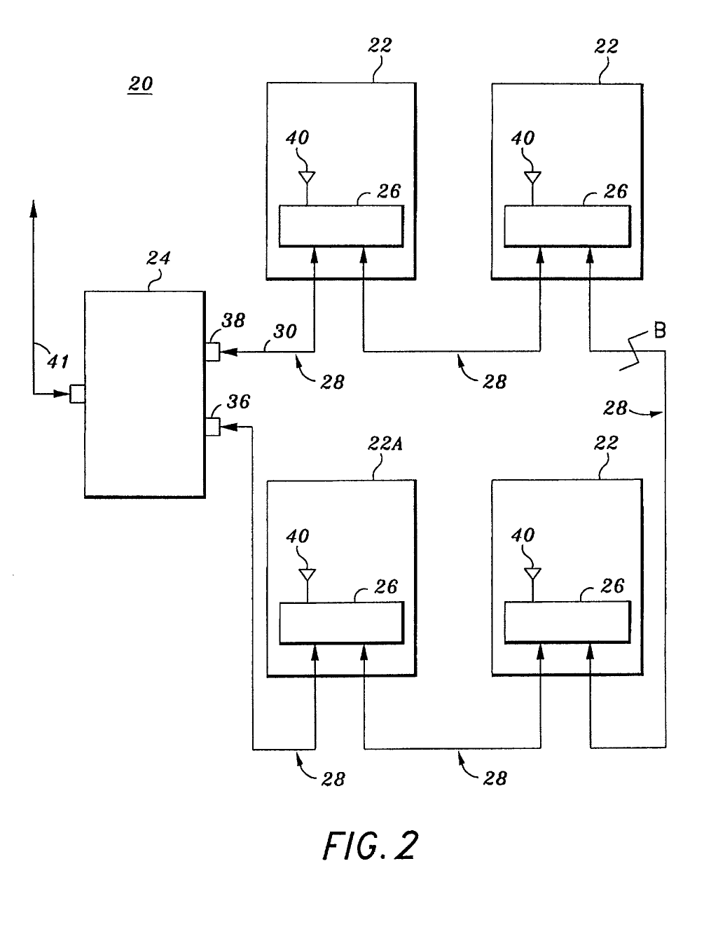

A gaming network 20 in accordance with one embodiment of the present invention will be described generally with reference to FIG. 2. As illustrated therein, the network 20 includes a gaming gateway or host 24 and one or more gaming devices 22. While the term gaming gateway is used herein to refer to a particular portion or component of the invention, it will be appreciated that this component may have a variety of other names, such as host, server or the like. Regardless of its name, the gaming gateway preferably has one or more of the characteristics, properties or capabilities as detailed below.

The gaming devices 22 may be of a variety of types. In one or more embodiments, the gaming devices 22 comprise machines which are arranged to accept a wager by a player and then pay the player an award in the event the player receives a winning event. For example, the gaming devices 22 may be slot-type machines, video poker machines, lottery machines or the like. Of course, the gaming devices 22 may comprise a variety of other devices, such as electronic video games, pinball games and other devices where communication between devices or with the device from a remote location is desired.

The network 20 will now be described in more detail with reference to FIG. 2. A communication interface 26 is associated with each gaming device 22. In general, each communication interface 26 comprises a transceiver, i.e., a data receiver and a data transmitter. The communication interface 26 of a particular gaming device 22 includes a communication link 40 over which data may be transferred to and from the gaming device 22.

The gaming gateway 24, which may also be referred to as a host or central server, itself generally comprises a communication interface, arranged to send and receive information. In general, the gaming gateway 24 comprises a transceiver, i.e., a data receiver and a data transmitter. The gaming gateway 24 includes a communication link 41 over which data may be transferred to and from other systems, networks and devices.

In order to permit communications between the various gaming devices 22 of the network 20 and the gaming gateway 24, one or more communications links 28 are provided. In one embodiment, a communications link 28 is provided between each gaming device 22 and the gaming gateway 24. In a preferred embodiment, the network 20 topology is one of a closed loop. In this arrangement, a communications link 28 is provided between the gaming gateway 24 and a first gaming device 22, between the first and a second gaming device 22, and so on to the last gaming device 22, and from the last gaming device 22 back to the gaming gateway 24. As discussed in more detail below, in this arrangement, a communications link is provided between each gaming device 22 and the gaming gateway 24, although such may along a pathway including another gaming device 22.

In a preferred embodiment, each communication link 28 comprises an optical fiber for transmitting information from one point to another in the form of light waves. Such optical fiber is well known and may comprise plastic or glass fiber available from Dow-Corning or other sources.

In a preferred embodiment, the gaming gateway 24 and individual communication interfaces 26 are arranged to send and receive data at very high speeds. In one or more embodiments, the gateway 24 and communication interfaces 26 may be adapted to employ an IEEE-1394 (Fire Wire®) protocol. Such a protocol, including its various features and details, are well known to those of skill in the art. Therefore, only those aspects of the protocol which relate to an implementation of the present invention are detailed herein. It is contemplated that one or more other protocols may be utilized instead of IEEE-1394, such as custom protocols capable of implementing the invention as described herein.

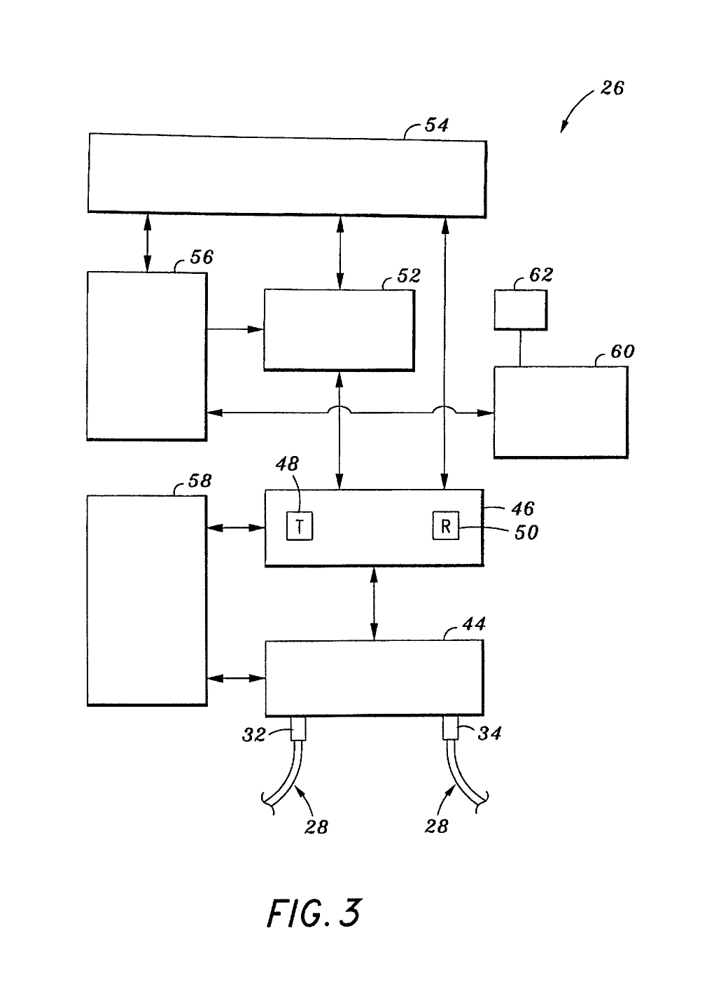

An embodiment of a particular communication interface 26 adapted to employ the IEEE-1394 protocol is illustrated in FIG. 3. The communication interface 26 at each gaming device 22 includes a physical layer 44 comprising physical hardware for receiving the optical fiber. In one embodiment, this physical layer 44 includes a first port 32 and a second port 34. Each port 32,34 comprises a connection/interface with an optical fiber. Preferably, the ports 32,34, including the associated hardware of the physical layer 44 are arranged to both send and receive data to and from its associated optical fiber.

As is well known, the physical layer 44 may comprise other hardware and even software, for performing a variety of functions. For example, hardware and/or software may be provided for encoding and decoding incoming and outgoing signals.

The communication interface 26 also includes a link layer 46. In a preferred embodiment, the link layer 46 is associated with the physical layer 44. In one embodiment, the link layer 46 also comprises a variety of hardware. In one or more embodiments, the link layer 46 includes a data packet transmitter 48 and a data packet receiver 50. In this arrangement, packets of data pass from the optic fibers through one of the first or second ports 32,34 of the physical layer 44 to the packet receiver 50. Likewise, packets of data are transmitted by the packet transmitter 48 from the link layer 46 to an optic fiber through one or the first or second ports 32,34.

In one or more embodiments, the communication interface 26 includes a transaction layer 52. In one embodiment, the transaction layer 52 comprises firmware which is in communication with the link layer 46. The transaction layer 52 is arranged to transmit data packets to the link layer 46 and to receive data packets from the link layer 46.

As stated above, information passes to and from the gaming device 22 and communication interface 26 via a communication link 40. As illustrated, the transaction layer 52 and link layer 46 communicate with a machine interface 54 of the gaming device 22. As is known, this interface may comprise hardware and software. For example, the interface 54 may include software drivers. The machine interface 54 may also include a bus bridge establishing a connection with a bus associated with a computing device (not shown) of the gaming device 20. For example, the gaming device 20 may include a computer having a processing device. A bus may be associated with the processing device for connecting various peripheral devices thereto. The bus may be of a variety of types, including custom busses of the PC 16/32 bit type, or may be of commercially available standard types, such as a PCI bus.

In one or more embodiments, the gaming device 20 may have a number of sub-systems such as a player tracking system and a progressive system. As stated in the Background, currently such sub-systems are arranged to receive information from independent network connections. In accordance with the present invention, information associated with a variety of systems is transferred to and from the gaming device 20 via the single network 20. In this particular embodiment, the communication interface 26 includes a node controller 58, resource manager 56 and/or one or more other elements useful in routing information to and from these sub-systems.

Referring again primarily to FIG. 2, the gaming gateway 24 is arranged to send and receive information. In this regard, the gaming gateway 24 also includes at least one first port 36 and second port 38 comprising connections/interfaces with optic fibers.

In one or more embodiments, the gaming gateway 24 is configured to implement an IEEE-1394 communications protocol. In this embodiment, the gaming gateway 24 may be similarly arranged so that each communication interface 26 associated with a gaming device 22. Although not shown, the gaming gateway 24 may thus include a physical layer including the at least one first and second port 36,38, a link layer, a transaction layer and one or more interfaces.

It will be appreciated that a variety of architectures can be arranged for implementing the IEEE-1394 or other communications protocol other than those described above. In addition, the architectures of the gaming gateway 24 and gaming devices 22 may vary from one another.

As described in more detail below, in the preferred embodiment of the invention, data can flow bi-directionally not only through each link 28 (“duplexing”), but through the entire network 20 due to the loop configuration of the network connecting each gaming device 22 to the gaming gateway 24 or other host. In the illustrated embodiment, this bidirectional flow is permitted through two communications links with each gaming device 22 and the gaming gateway 24. Referring to FIG. 2, with respect to the gaming device labeled 22A, data may be received from or transmitted to the gaming gateway 24 via the direct communication link 28 there between. In addition, data may be received from or transmitted to the gaming gateway 24 along a communication pathway extending through each of the other gaming devices 22 and associated communications links 28 back to the gaming gateway 24.

In one or more embodiments of the invention, data may be transmitted by the gaming gateway 24 or any communication interface 26 in asynchronous, synchronous or isochronous form, as is necessary. Some applications require data transfer to occur without any data corruption. Such data transfers can be accomplished with an asynchronous transfer. On the other hand, some data transfers must be at a relatively constant rate, data corruption being less of an issue. For example, to provide streaming audio at a gaming device 22, audio data must continually be provided to the gaming device 22. An isochronous data transfer is particularly useful in such a situation.

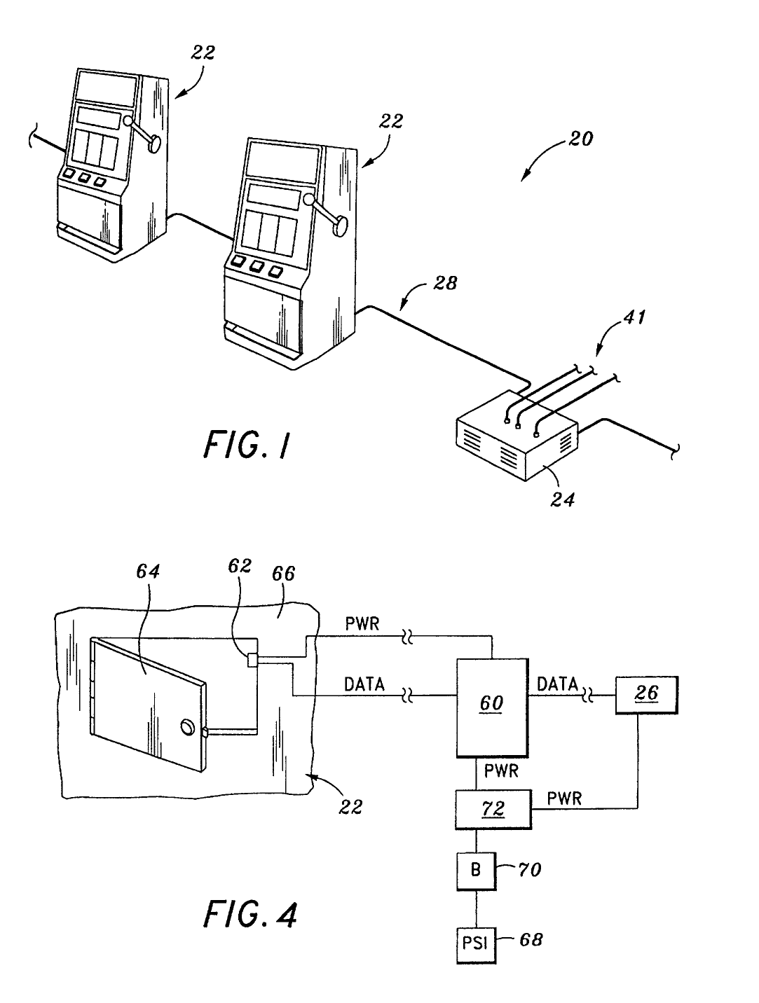

In one or more embodiments, means for sensing a gap or break in the network 20 is provided. Preferably, this means comprises a means for sensing if a gap exists along the otherwise closed loop through the interfaces 26 and communications links 28. This means may comprise software and/or hardware associated with the gaming gateway 24 or the communication interfaces 26. For example, the gaming gateway 24 may be arranged to send a service request signal to each gaming device 22 along one particular path of the network loop, such as in the direction starting with the port 38 illustrated in FIG. 1. In the event a particular gaming device 22 or others sequentially thereafter along that path do not respond, the gaming gateway 24 can confirm the location of a break in the network 20. In such event, the gaming gateway 24 can be arranged to interrogate the remaining pathway in an attempt to confirm communications with the remaining device(s). In the event of a break in the network 20, the gaming gateway 24 can configure itself to send data along the particular path via which particular devices(s) can be communicated with. The gaming gateway 24 can also be configured to send appropriate signals to each gaming device 22 to instruct the communications interface 26 thereof to also transmit data along the pathway which leads from that gaming device 22 back to the gaming gateway 24.

As will now be appreciated, the term “bi-directional” has applicability to two different aspects of the network. First, data may be sent in either/both directions between two devices along a communications link 28, such that communications between the two devices are “bi-directional,” i.e. data may flow in one direction along the link 28 from a first device to a second device, and data may flow in the opposite direction along the link 28 from the second device to the first device. As noted above, this feature of the invention may alternately be referred to as a “duplex” feature, i.e. the simultaneous transmission and reception of signals in two directions. In one embodiment, this duplexing feature may be implemented by each link 28 comprising two separate optic fibers, one for transmitting data in a particular direction and the other for receiving data. In a preferred embodiment, the links 28 comprise a single fiber carrying data in two directions. In this preferred embodiment, data may be transmitted in opposing directions by signals having different frequencies.

As used generally herein, the term “bi-directional” more generally refers to the fact that data may be transmitted from a single device of the network in more than one direction. For example, in the preferred embodiment where the network topology is one of a loop, each device may transmit data along the network loop in either direction. For example, data may be transmitted from the gaming gateway 24 around the loop in either a clock-wise or counter-clockwise direction. In addition, as described above, regardless of the particular direction that a device transmits, preferably communications along that path are duplexed, i.e. data is being sent to that device in the opposite direction along the same path.

In accordance with the invention, data is transmitted in packets, each packet having an address identifying its intended destination. An aspect of the network 20 of the invention is that each communication interface 26 and the gateway 24 is adapted to receive a particular data packet if addressed to it, or to retransmit the data packet along the network 20 to the appropriate location if not addressed to it.

Thus, one aspect of the invention is implementation of a particular protocol which permits any device on the network 20 to communicate with any other device.

In one or more embodiments, the gaming gateway 24 is a stand-alone device. In another embodiment, the gaming gateway 24 is part of another device, such as a central host computer. This central computer may be arranged to perform a variety of functions, including tracking of all data received from all of the gaming machines, storing and manipulating the data, exporting the data to other systems, and interfacing with an operator or user. As a result of the various configurations which the gaming gateway 24 may have, the gateway may be referred to as a remote device, a host or central host, server or by other terminology. In general, it should now be understood, however, that the gaming gateway 24 at a basic level comprises one device on the network 20 with which communications are desired to be maintained, and in particular, such a device which may be located remote and with which communications with all of a group of one or more gaming devices 22 is to be maintained.

In a preferred embodiment, the gaming gateway 24 of the network 20 links the gaming devices 22 in communication with one or more other networks or systems. In one embodiment, the gaming gateway 24 is linked to back-bone networks such as player-tracking, progressive and other independent networks. In one or more embodiments, the gaming gateway 24 is configured to communicate with devices, systems or networks operating in accordance with a variety of different protocols. For example, other systems that the gaming gateway 24 communicates may operate in accordance with an Ethernet or ATM protocol. The gaming gateway 24 may also be arranged to communicate with a host or other system both via a wired communication link or a wireless link.

A great number of advantages are realized with the method and network 20 of the present invention. One advantage is the providing of a single network 20 through which one or more gaming devices 22 may communicate with a plurality of different systems or other networks. Existing gaming devices 22 which currently have multiple independent network connections to multiple networks, such as player-tracking and progressive networks, can be connected to all of these networks/systems via the single network 20 of the present invention. Further, each gaming device 22 that couples to the network 20 of the present invention can later connect to a variety of other outside systems/networks using the present network 20 without the need for additional network connections for each gaming device 22. The network 20 of the invention is also useful in that it can connect a plurality of gaming devices 22 to outside systems/networks, where each of the gaming devices 22 on the network 20 is independently configured. For example, the network 20 may be used to connect a first gaming device 22 which is only configured for a progressive system and a second gaming device 22 which is only provided with a player-tracking feature. Both of these differently configured gaming devices 22 can be part of the same network 20.

A primary advantage of the arrangement of the invention is a more reliable communications network 20 for a gaming device 22. In accordance with the arrangement of the invention, if the communication link is broken anywhere along the network 20, communications are unimpeded to and from any particular gaming device 22 and the gaming gateway 24. Such a breakage may result from physical destruction of the optic fiber, unplugging of a fiber from a port or other factors.

With reference to FIG. 2, assume that a change cart is rolled over the optic fiber at point B and physically breaks the fiber. It will be appreciated that those gaming devices 22 on either side of the break can communicate with the gaming gateway 24 via the communication links 28 which remain.

In this regard, the network 20 may be said to be “self-repairing.” In other words, before the break, data may be routed along a particular pathway in a loop-fashion. After a break, the data may be rerouted, as necessary, along either branch of the loop to reach the appropriate destination.

For this same reason, problems associated with the movement of gaming devices 22 are overcome. As described, the communications link may be broken along the pathway or loop without having communications interrupted. An operator may completely unplug a particular gaming device 22 or cut one of the optic fibers in order to move a machine or a bank of machines. As described above, in that event, communications are still permitted using the remaining communications pathways.

Repair of the gaming devices is facilitated by the method and network of the invention. It is common for gaming device 22 to be arranged in banks or carousels, where the devices are very closely spaced. In addition, the devices 22 may all be mounted to a common platform, with wiring connecting the devices 22 routed through the platform and interconnected with each device 22. In this arrangement it is often necessary to completely disconnect a particular device 22 from the others in order to access or move the device 22 for access during repair. In the prior art, this step would result in a breach of the communications network as to all gaming machines, or at least those of the entire bank or carousel, and not just the single device 22 which is intended to be repaired. In accordance with the invention, a device 22 in such an arrangement can be completely disconnected from the network 20 and communications are still permitted by and between the remaining devices 22 and the gaming gateway 24.

An advantage of the invention is the use of optic fiber to form a communication link 28 for gaming devices 22. The optic fibers are capable of carrying large amounts of information. The optical signals traveling along an optic fiber are not susceptible to electromagnetic interference, electrical impulse transmission and interference and similar data disrupting events. For example, static electricity and electromagnetic fields (such as those associated with gaming device video monitors and the like) do not interfere with the light wave data transmitted over the optic fiber. This eliminates many sources of data corruption, interference and error associated with non-fiber based networks.

Another advantage of using optic fiber is that certain aspects of network maintenance and verification are simplified. In accordance with the invention data is transmitted over the optic fibers using light in a visible light band. A technician can, at one level, verify operation of the network 20 by examining a fiber or a port for the existence of visible light representing information being transmitted over the network 20. If no light is visible, an indication is provided that there may be a physical break in the network or a malfunction of one of the communication interfaces 26 or the gaming gateway 24.

An additional advantage of the method and apparatus of the invention comprises security of the gaming network 20 and each individual gaming device 22. It is very important to ensure the integrity of each gaming device 22 and desirable to secure each device 22. First, large amounts of cash or coins may be stored in the cabinet of such a gaming device 22 which must be protected. Second, tampering with the devices 22 must be avoided to prevent unauthorized awards of winnings. The variety of ways by which gaming thieves attempt to steal monies from such devices 22, including tampering with the operation of the device 22, are well known.

As one aspect of the invention, the network 20 may be used for certain security functions. First, each gaming device 22 may be arranged to send operating data to a central host through the gaming gateway 24. This information can be used to verify that the gaming device 22 is operating correctly. This information can include amounts of money accepted (such as by player credit cards, accepted cash or coins), and results of games including payouts for particular game results. Information such as overly frequent wins, larger payouts than authorized for particular wins and similar discrepancies in information can be used to identify a breach in the security of the device to appropriate personnel.

An additional security feature of the invention will be described with reference to FIGS. 3 and 4. In one or more embodiments, a security monitoring system 60 is associated with the gaming device 22 and the network 20 in general. In one or more embodiments, the security monitoring system 60 includes a door monitor 62. The monitor 62 includes one or more sensors, such as optical or electrical sensor(s) arranged to detect the opening of one or more of the doors 64 or other means of access to the interior of the gaming device 22. One means by which thieves attempt to rob gaming devices 22 is by removing the cash box through a main access door.

In one or more embodiments, the sensor(s) 62 is arranged to provide a signal to the gaming device communication interface 26 indicative of the state of the sensor. In this manner, the sensor 62 may indicate to the communication interface 26 whether an access door 64 of a cabinet 66 is open or closed. The gaming interface 26 is, in turn, arranged to send one or more signals to the gaming gateway 24. In one embodiment, a signal may only be sent in the event the door is moved to an open position. In another embodiment, a signal is sent periodically regardless of the status of the door, this periodic signal itself confirming the operation of this security function.

In a preferred embodiment of the invention, the communication interface 26 and the associated security monitoring system 60 may be operated from a power supply independent from that which supplies power to the remainder of the gaming device 22. In one or more embodiments, the gaming device 22 may be powered from a power cord PSI connected to a main power supply 68. The power supply for the communication interface 26 and security monitoring system 60 may comprise one or more rechargeable batteries 70 capable of receiving power from, when available, the power supply 68 for the gaming device 22. In such event, if the power supply to the gaming device 22 is broken or lost, such as if intentionally disconnected or in the event of a power outage, power is still supplied to the communication interface 26 and security monitoring system 60 via the rechargeable battery(ies) 70. Of course, it is contemplated that a wide variety of other arrangements for providing power to the communication interface 26 and security monitoring system 60 are contemplated. For example, the interface 26 and security monitoring system 60 may be powered through a separate power supply which normally obtains power from a main power system, but in the event of a failure has an automatic standby power supply, such as by generator.

In a preferred embodiment of the invention, even if the main power supply to the gaming device 22 is turned off or lost, the communications interface 26 and security monitoring system 60 continue in operation. In one embodiment, a controller 72 may be provided for turning on and off the communication interface 26 and security monitoring system 60 for short durations over time to conserve power usage. During each “on” interval, data may be provided from the security monitoring system 60 to the communications interface 26, and then transmitted to the gaming gateway 24. The information received at the gateway 24 (such as forwarded to a main host monitor) may be used to determine the security of the gaming device 20.

In one embodiment of the invention, a memory (such as RAM, DRAM, SDRAM or another type of memory element) is associated with the one or more security monitoring sensors. Sensor output is stored in this memory. Power may be supplied to the sensors for monitoring the doors and other access points at all times, with this data stored in the memory. Then, during an “on” condition of the remainder of the system 60 and the communication interface 26, a packet of data representing a block of this monitoring data may be sent to the gaming gateway 24. For example, each sensor may be configured to provide an output signal every 0.1 s, and each “on” condition may be every 10 s, such that during each “on” condition, 100 stored data signal elements are transmitted.

It will be appreciated that the frequency of the operation of the communication interface 26 and security monitoring system 60 substantially determines the length of time which these functions remain operational using a fixed maximum amount of backup power supply. Thus, if the “on” conditions are less frequent, the total time the security functions can remain operational over time is increased. On the other hand, it is desirable for the have the security signals transmitted frequently enough that if a breach in one of the door occurs, it is detected quickly enough for the operator to send appropriate security personnel to catch the perpetrator.

As one aspect of the invention, data regarding the security features of the security system may be continuously stored at the memory of the monitoring system 60. This data may include the date, time and nature of a particular security breach or other relevant activity. This monitoring continues regardless of the whether the communication network is operational. Further, in the event there is a complete failure of the communication network, the monitoring system 60, as associated with the interface 26, may still maintain security system monitoring until such time as the communication network is again operational. At that time, security information may immediately be transmitted to the gaming gateway 24.

It will be understood that the above described arrangements of apparatus and the method therefrom are merely illustrative of applications of the principles of this invention and many other embodiments and modifications may be made without departing from the spirit and scope of the invention as defined in the claims.

I claim:

1. A communication network for at least one gaming device comprising:
a host communication device capable of transmitting and receiving data;
at least one gaming device;
a communication interface associated with said at least one gaming device; and
a communication link provided between said at least one gaming device and said host communication device, said communications link comprising at least one optic fiber, said host communications device and communications interface associated with said at least one gaming device configured to bi-directionally communicate data over said communication link.

2. The network in accordance with claim 1 wherein said communication interface is in communication with at least two of said communication links.

3. The network in accordance with claim 1 wherein said communication interface includes at least two ports, each port connected to one of said optic fibers.

4. The network in accordance with claim 1 wherein said network has a loop topography, said loop extending from said host to each of said gaming devices back to said host.

5. The network in accordance with claim 1 wherein said host communication device and communication interface are adapted to implement an IEEE-1394 protocol.

6. The network in accordance with claim 1 wherein said communication interface and host communication device are adapted to transmit data over said optic fiber using a visible light band.

7. The network in accordance with claim 1 wherein at least one optic fiber extends between said host communication device and a first gaming device, between a last gaming device and said host communication device, and between said first and last gaming device and every gaming device there between.

8. The network in accordance with claim 1 including a security monitoring system associated with each gaming device and in communication with said communication interface.

9. The network in accordance with claim 8 wherein said security monitoring system includes at least one sensor for detecting a condition of a door of a cabinet of said gaming device.

10. The network in accordance with claim 8 wherein said security monitoring system includes at least one memory device for storing security data.

11. The network in accordance with claim 8 including a first power source associated with said gaming device and a second power source for independently powering said communication interface and security monitoring system.

12. The network in accordance with claim 11 wherein said second power source is arranged to provide power in the event power is not available from said first power source.

13. The network in accordance with claim 11 wherein said second power source includes at least one rechargeable battery.

14. The network in accordance with claim 4 wherein at least said host communication device is adapted to detect a break in said network loop.

15. A communication network for receiving information from and sending information to at least one gaming device comprising:
a bi-directional communication interface associated with said gaming device;
at least one remote bi-directional communication host device;
at least one optical communication link between said bi-directional communication interface and bi-direction communication host device.

16. The network in accordance with claim 15 wherein said at least one optical communication link comprises an optic fiber.

17. The network in accordance with claim 15 wherein said bi-directional communication host device comprises a host computer.

18. The network in accordance with claim 15 including at least one gaming device security system, said system monitoring at least one condition of access to said device and providing information regarding said at least one condition to said bi-directional communication interface for transmitting to said host device.

19. The network in accordance with claim 15 including multiple gaming devices arranged along a sequential network loop beginning with said bi-directional communication host device and ending with said bi-directional communication host device.

20. A security system for a gaming device having a cabinet and at least one access door and a primary power supply comprising:
a security monitoring system including at least one sensor for outputting data regarding a condition of said at least one access door;
a communication interface for receiving said condition data from said security monitoring system and providing said condition data to a remote location; and
a secondary power supply for powering said security monitoring system and communication interface during a period in which power is not available from said primary power supply.

21. The security system in accordance with claim 20 wherein said secondary power supply comprises at least one rechargeable battery.

22. The security system in accordance with claim 20 wherein said security monitoring system includes at least one memory element for storing said condition data.

23. The security system in accordance with claim 21 including a controller for selectively providing power from said secondary power supply at spaced intervals.

24. A communication network for at least one gaming device comprising:
a host communication device, said host communication device adapted to receive information from and transfer information to at least a second network;
at least one gaming device;
a communication link provided between said at least one gaming device and said host communication device;
a communication interface associated with said at least one gaming device and coupled to said communication link, said communication interface adapted to transmit information to one or more features of said gaming device associated with said second network.

25. The communication network in accordance with claim 24 wherein said host communications device and communications interface associated with said at least one gaming device configured to bi-directionally communicate data over said communication link.

26. The communication network in accordance with claim 24 wherein said network is adapted to transmit said information in accordance with a first protocol and said second network transmits information in accordance with a second protocol.

27. The communication network in accordance with claim 24 wherein said first protocol comprises IEEE-1394 and said second protocol is a protocol/architecture selected from the group consisting of: IEEE-804.2, ATM, custom and wireless.

28. A method of transferring information to one or more gaming devices comprising:
providing a communication host;
providing at least one communication link to said one or more gaming devices;
transmitting information from a plurality of remote systems to said host;
transforming said information and transmitting said information from said host to said one or more gaming devices over said communication link.

29. The method in accordance with claim 28 wherein said remote systems operate in accordance with a different protocol than said communication host.

30. The method in accordance with claim 28 including the step of distributing information received by said gaming device over said communication link to one or more systems of said gaming device associated with said remote systems.
